(19) United States
(12) Patent Application Publication
(10) Pub. No.: US 2012/0287445 A1
(43) Pub. Date: Nov. 15, 2012

(54) INFORMATION PROCESSING APPARATUS, IMPOSITION METHOD, AND STORAGE MEDIUM

(75) Inventor: Hiroyuki Kayama, Yokohama-shi (JP)

(73) Assignee: CANON KABUSHIKI KAISHA, Tokyo (JP)

(21) Appl. No.: 13/459,938

(22) Filed: Apr. 30, 2012

(30) Foreign Application Priority Data
May 10, 2011 (JP) 2011-105380

(51) Int. Cl. G06K 15/02

(52) U.S. Cl. 358/1.2

(57) ABSTRACT

An information processing apparatus includes a setting unit configured to set whether to enlarge a print area to a size of a tab area, and an imposition unit configured to, when a setting to enlarge the print area to the tab area is set by the setting unit, enlarge the print area to the size of an index sheet and perform imposition of an image of original data of a page to be processed, on the enlarged print area.

### BACKGROUND OF THE INVENTION

1. Field of the Invention

The present invention relates to an information processing apparatus, an imposition method, and a storage medium.

2. Description of the Related Art

When original data which consists of a character, a table, or an image is processed, since the structure that defines the original data and the operation necessary in editing the original data are changed, various application programs that can process various types of original data are provided. The user of the application programs selects an application program according to the type of the original data. For example, the user uses a character processing program for editing a character, a spreadsheet program for editing a table, and an image editing program for editing an image.

Generally, the user changes the application program according to the type of the original data. However, the document the user intends to generate often includes original data of more than one type. For example, the original data is often a combination of a character and a table or a character and an image rather than original data that consists only of characters, tables, or images. Thus, a document processing system which serves as an integrated application capable of processing various types of original data and generating one consolidated document from the original data is provided.

Such a document processing system as an integrated application allows reading of plural pieces of original data generated by the user using an application and making a print setting (e.g., setting of paper size and finishing processing) which is used when the data is output by the printer. Further, according to a print command issued by the user, after an outside unnecessary portion is cropped, each page of the original data is arranged (imposed) in an appropriate area according to the print setting. Then, the obtained result is transmitted to the printer together with the print setting command. In this manner, an output result the user desires can be obtained.

The document processing system is capable of making an index sheet (tab paper) setting as one type of print setting. According to this setting, an index sheet for dividing the document can be inserted at an intended position when the sheets are output by the printer.

According to a technique of a conventional document processing system, which is discussed in Japanese Patent Application Laid-Open No. 2003-54825, a character string of an index (tab) portion can be printed on an index (tab) portion of an index sheet by shifting the print position of the image of the original data including the character string.

However, according to the conventional technique described above, if a page image of a size of the index sheet is included in the original data, the user is unable to obtain the desired print result. To be more precise, if a page image having a size of an index sheet and including both the body portion and the index (tab) portion of the index sheet is included in the original data, the user is unable to obtain the desired print result.

For example, if a page image such as a page image 1601 (image size: size of index sheet, an image of a body portion: “A”, an image of an index (tab) portion: “ABCDEFG”) illustrated in FIG. 16 is included in the original data, and if this image is arranged in a print area 1602 whose size is the same as other pages of the original data, the image of the index (tab) portion outside the print area is cropped out and is not printed in the print area. Thus, as a print result 1603 shows, the index sheet output from the printer does not include the image of the index (tab) portion.

Further, if the page image is shifted to be arranged in the print area so that the image of the index (tab) portion is included in the print area 1602 (imposition shift), a portion of the body portion which is shifted out of the print area is deleted (clipped). Thus, as a print result 1604 shows, a part of the image of the body portion is not printed on the index sheet output from the printer.

Further, the original data generated by the user using an application is provided in a variety of forms. In other words, as described above, the page to be printed on the index sheet may have an image size same as the size of the index sheet and may or may not include an image of the index (tab) portion. Further, the image size may be the same as the size of the original page which is printed on a sheet other than the index sheet.

In the document processing system, processing is required that can realize a print result on the index sheet which the user desires regardless of the form of the original data.

### SUMMARY OF THE INVENTION

The present invention is directed to obtaining a print result which the user desires on an index sheet regardless of the form of the original data.

According to an aspect of the present invention, an information processing apparatus includes a specification unit configured to specify a page to be printed on a tab sheet, of original data including a plurality of pages, an enlarging unit configured to enlarge a print area of the page specified by the specification unit to a size of a print area of the tab sheet, and a generation unit configured to generate print data of the page to be printed on the tab sheet specified by the specification unit using the print area enlarged by the enlarging unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a software configuration of a document processing system.

FIG. 2 illustrates an example of a hardware configuration of the document processing system.

FIG. 3 is a schematic drawing of an example of a format of a book file.

FIG. 4 illustrates an example of a list of book attributes.

FIG. 5 illustrates an example of a list of chapter attributes.

FIG. 6 illustrates an example of a list of page attributes.

FIG. 7 is a flowchart illustrating procedures which are executed when the book file is opened by a bookbinding application.

FIG. 8 illustrates an example of a user interface (UI) screen which is displayed when the book file is newly generated.

FIG. 9 illustrates an example of a user interface screen which is displayed when an existing book file is opened.

FIG. 10 is a flowchart illustrating electronic original importing procedures.

FIG. 11 is a flowchart illustrating procedures of an electronic original writer generating an electronic original file in step S801 in FIG. 10.

FIG. 12 illustrates an example of an “index sheet setting” window of the bookbinding application.

FIG. 13 is a flowchart illustrating an example of procedures by which an electronic original despooler performs imposition processing of the original data in the document processing system.

FIG. 14 illustrates an example of a print result obtained by the electronic original despooler performing the imposition processing of the original data on an index sheet according to the flowchart in FIG. 13, and the printer performing the print processing.

FIG. 15 is a flowchart illustrating an example of procedures of the electronic original despooler performing the imposition processing of the original data in the document processing system according to a second exemplary embodiment of the present invention.

FIG. 16 illustrates an example of a print result obtained from the imposition processing and the print processing on an index sheet according to a conventional technique.

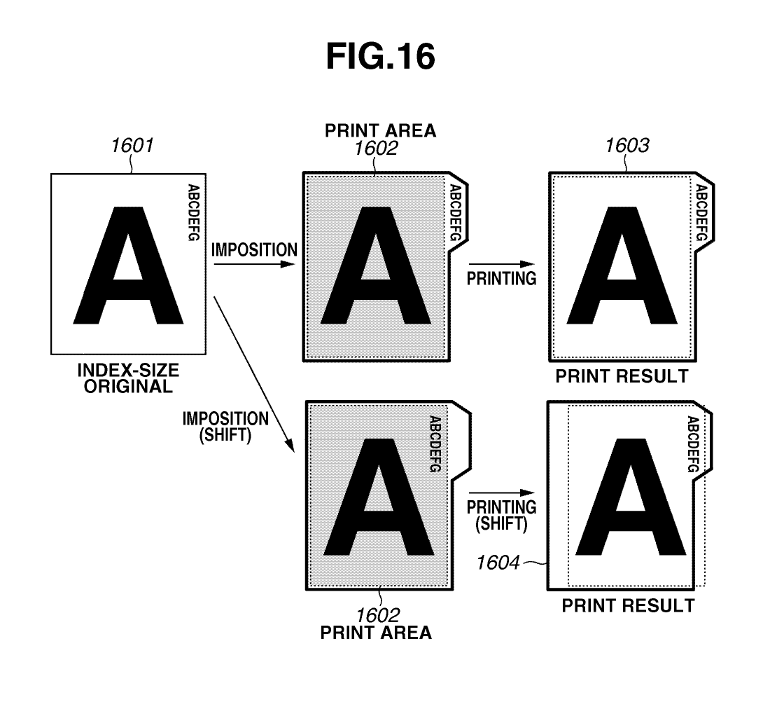

### DESCRIPTION OF THE EMBODIMENTS

Various exemplary embodiments, features, and aspects of the invention will be described in detail below with reference to the drawings.

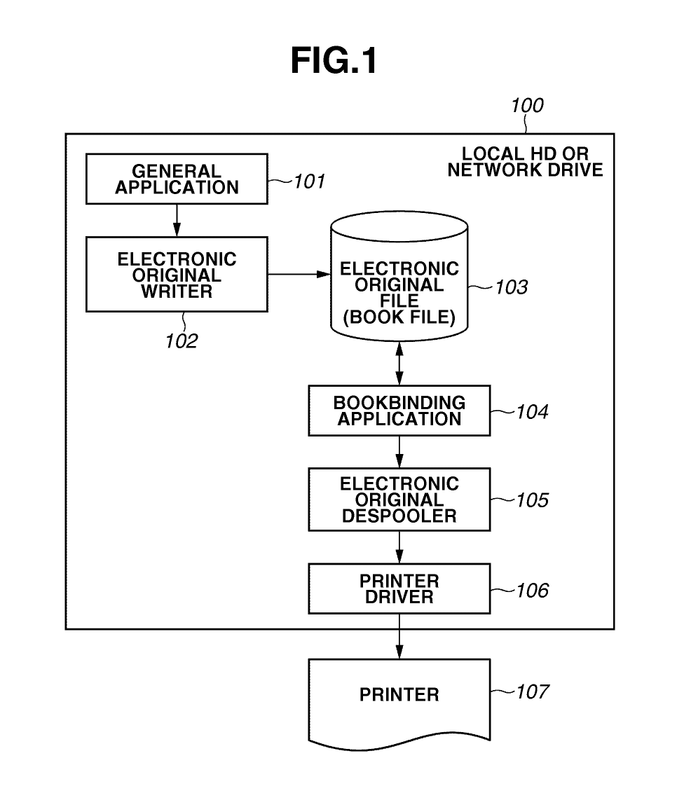

First, a document processing system of a first exemplary embodiment will be described with reference to FIGS. 1 to 14.

### <Software Configuration of Document Processing System>

FIG. 1 illustrates an example of a software configuration of a document processing system. The document processing system is realized by a digital computer 100 (also referred to as a host computer hereinafter) as an embodiment suited to a document processing apparatus (information processing apparatus) of the present invention.

A general application 101 is an application program providing functions such as word-processing, spreadsheet, photo retouching, draw, paint, presentation, and text editing. The general application 101 also includes a printing function corresponding to an operating system (OS). When application data (original data) such as generated document data or image data is printed, a predetermined interface (generally called graphics device interface (GDI)) provided by the OS is used.

To be more precise, in order to print generated print data, the general application 101 issues an output command (called a GDI function) which is determined in advance, to an output module of the OS providing the interface. The output command has an OS-dependent format. The output module that received the output command converts the command into a format which can be processed by an output device such as a printer, and outputs the converted command. The converted command is called a device driver interface (DDI) function.

Since the format which can be processed by the output device is different according to the device type, manufacturer, and model, a device driver is provided for each output device. By using such a device driver, the OS converts the command, generates print data, describes the print data using a job language (JL), and generates a print job. If Windows (registered trademark) of Microsoft Corporation is used as the OS, a GDI module is operable as the above-described output module.

An electronic original writer 102 is an improvement of the above-described device driver, and is a software module provided for the realization of the document processing system. The electronic original writer 102 does not target a specific output device. The electronic original writer 102 converts an output command into a format which can be processed by a bookbinding application 104 or a printer driver 106 described below.

The format (referred to as an “electronic original format” hereinafter) obtained by the conversion performed by the electronic original writer 102 is not limited to a specified format so long as each original page can be expressed in a detailed format. For example, Portable Document Format (PDF) format and ScanScope Virtual Slide (SVS) format can be used as the electronic original format among actual standard formats.

If the electronic original writer 102 is used by the general application 101, the electronic original writer 102 is designated as a device driver used for the output, and then the printing is executed. However, an electronic original file generated by the electronic original writer 102 does not have complete electronic original file formats. For this reason, the electronic original writer 102 is designated as a device driver by the bookbinding application 104 and the application data is converted into an electronic original file under the control of the bookbinding application 104.

The bookbinding application 104 completes the new electronic original file generated by the electronic original writer 102 as an electronic original file with a format described below. In the following description, a file generated by the electronic original writer 102 will be called an electronic original file and an electronic original file which is given a structure by the bookbinding application 104 will be called a book file when these files need to be distinguished. However, if the files do not need to be distinguished, the document files generated by an application, an electronic original file, and a book file are called document files (or document data).

As described above, the electronic original writer 102 is designated as the device driver and data is printed by the general application 101. In other words, the application data is converted into an electronic original format in a unit of a page defined by the general application 101. These pages are hereinafter called “logical pages” or “original pages”. Then, the converted data is stored in a storage medium such as a hard disk as an electronic original file called a book file 103. The hard disk may be a local drive of the computer that realizes the document processing system of the present embodiment but can also be a drive provided on a network if the computer is connected to the network.

The bookbinding application 104 is provided with a function used for reading and editing the electronic original file or the book file 103. Further, the bookbinding application 104 is provided with a function used for editing the content (original image) of each page and generating a structure of a chapter or a book by treating a page as the smallest unit of the chapter and the book as described below.

When the book file 103 edited by the bookbinding application 104 is printed, an electronic original despooler 105 is started by the bookbinding application 104. The electronic original despooler 105 is a program module installed in the computer together with the bookbinding application 104. The electronic original despooler 105 is used when a document (book file) edited by the bookbinding application 104 is printed, to output rendering data to the printer driver.

The electronic original despooler 105 reads out a designated book file from the hard disk. To print each page in a format described in the book file, the electronic original despooler 105 generates an output command that matches the above-described output module of the OS, and outputs the generated output command to the output module (not illustrated). At this time, the printer driver 106 for a printer 107 used as an output device is designated as the device driver.

The output module converts the output command which has been received by using the designated printer driver 106 for the printer 107, into a device command which can be interpreted by the printer 107. Then, the device command is transferred to the printer 107 and an image corresponding to the command is printed by the printer 107.

### <Hardware Configuration of Document Processing System>

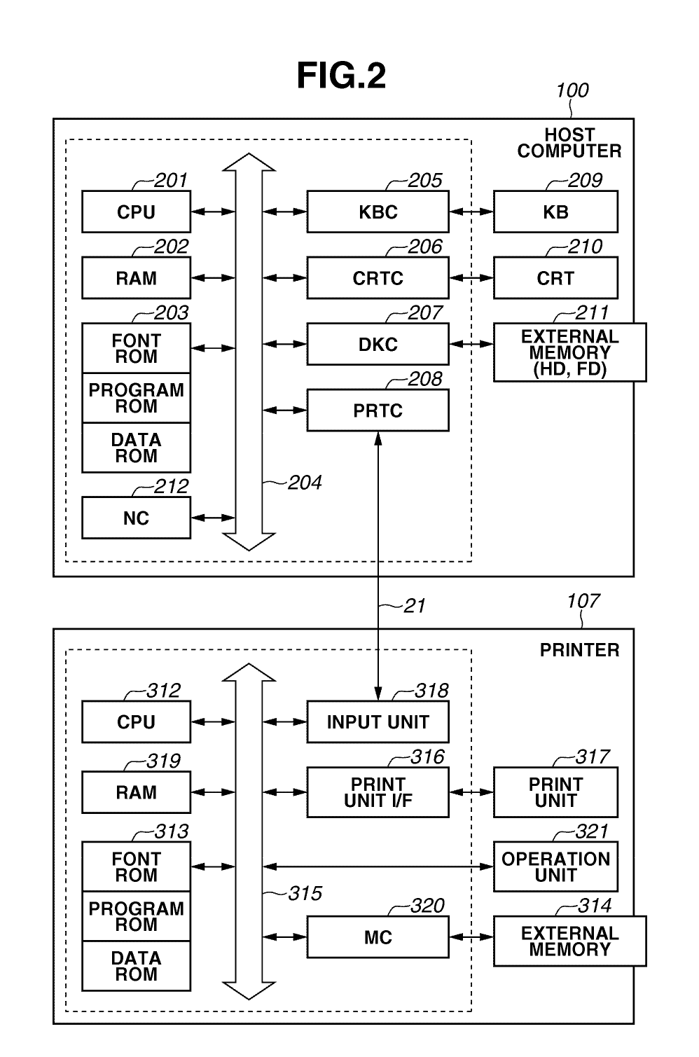

FIG. 2 illustrates an example of a hardware configuration of the document processing system. In FIG. 2, the host computer 100 includes a central processing unit (CPU) 201. The CPU 201 executes document processing of a document including a mixture of figures, images, characters, and tables (including spreadsheet) based on a document processing program stored in a program read-only memory (ROM) in a read-only memory ROM 203 or in an external memory 211. The CPU 201 performs overall control of each device connected to a system bus 204.

An operating system program, which is a control program of the CPU 201, is stored in the program ROM in the ROM 203 or the external memory 211. Font data used for the above-described document processing is stored in a font ROM in the ROM 203 or the external memory 211. Various types of data used for the above-described document processing is stored in a data ROM in the ROM 203 or the external memory 211. A random access memory (RAM) 202 functions as a main memory and a work area of the CPU 201.

A keyboard controller (KBC) 205 controls a key input from a keyboard (KB) 209 or a pointing device (not illustrated). A cathode ray tube controller (CRTC) 206 controls the display on a CRT display (CRT) 210. A disk controller (DKC) 207 controls access to the external memory 211. The external memory is, for example, a hard disk (HD) or a flexible disk (FD) that stores a boot program, various applications, font data, user file, edit file, and printer control command generation program (printer driver).

A printer controller (PRTC) 208 is connected to the printer 107 via an interface 21 which is bidirectional. The PRTC 208 controls communication with the printer 107. A network controller (NC) 212 is connected to the network and controls communication with another apparatus connected to the network.

The CPU 201 executes, for example, rasterization of an outline font on a display information RAM set on the RAM 202, thereby enabling WYSIWYG on the CRT 210. Further, based on a command instructed by a mouse cursor (not illustrated) on the CRT 210, the CPU 201 opens various registered windows and executes various types of data processing. When the user executes printing, the user opens a window relating to the print setting. Then, the user can set a print processing method including the printer setting and a print mode selection for the printer driver via the window.

The CPU 201 executes processing based on a program stored in a ROM or an external memory so that the software configuration of the host computer 100 illustrated in FIG. 1 and processing of each step of the flowchart described below are realized.

The printer 107 is controlled by a CPU 312. The CPU 312 of the printer outputs an image signal as output information to a print unit (printer engine) 317 via a print unit I/F 316 connected to a system bus 315 based on a control program stored in a program ROM in a ROM 313 or a control program stored in an external memory 314.

Further, a control program of the CPU 312 is stored in the program ROM in the ROM 313. Font data which is used when the above-described output information is generated is stored in a font ROM in the ROM 313. Information used on the host computer 100 is stored in a data ROM in the ROM 313 if the printer does not have the external memory 314 such as a hard disk.

The CPU 312 can communicate with the host computer 100 via an input unit 318 and notifies the host computer 100 of the information within the printer. A RAM 319 functions as a main memory or a work area of the CPU 312. The memory capacity of the RAM 319 can be increased by an optional RAM connected to an expansion port (not illustrated). The RAM 319 is used as an output information rasterization area, an environment data storage area, or a non-volatile RAM (NVRAM).

Access to the external memory 314 such as the hard disk (HD) or an integrated circuit (IC) card is controlled by a memory controller (MC) 320. The external memory 314 can be connected as an option to store font data, an emulation program, or form data. An operation unit 321 includes an operation panel. A switch for operating the printer and a light-emitting diode (LED) indicator is displayed on the operation panel.

Further, the external memory 314 described above is not limited to one memory and a plurality of memories can be provided. For example, in addition to a built-in font card, an optional card and a plurality of external memories storing programs for interpreting a printer control language of a different language system can be connected to the printer. Further, a NVRAM (not illustrated) used to store printer mode setting information transferred from the operation unit 321 can be included in the printer.

### <Electronic Original Data Format>

Before the bookbinding application 104 is described in detail, the data format of the book file will be described. The book file has a three-layered structure similar to a paper-medium book. The upper layer is called a “book”, resembles one book, and defines the attributes of the entire book. The middle layer corresponds to a chapter of a book, and is also called a “chapter”. Attributes of the chapter can be defined for each chapter. The lowest layer is called a “page”, and corresponds to each page defined by the application program. Attributes of the page can be defined for each page. One book can include a plurality of chapters and one chapter can include a plurality of pages.

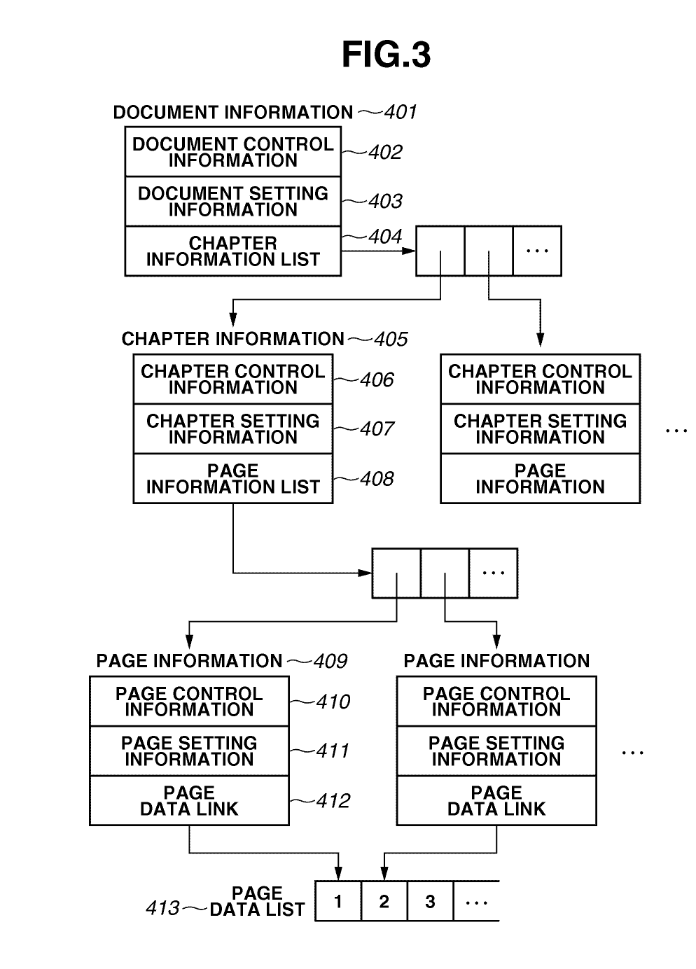

FIG. 3 is a schematic drawing of an example of a format of a book file. In the book file of this example, a book, a chapter, and a page are represented by corresponding nodes. One book file includes one book. Since the book and the chapter are concepts used in defining a book structure, each of them includes, as an entity, a defined attribute value and a link to the lower layer.

The page includes, as an entity, original data for each page output from the application program. Thus, in addition to the attribute value, the page includes an entity of each original page data (original page data) and a link to the original page. A print to be output onto a paper medium may include a plurality of original pages. This structure is not displayed as a link but as an attribute of the book, the chapter, or the page of each layer.

In FIG. 3, since a book file is not necessarily one completed book, the “book” is generalized and illustrated as a “document”.

First, document information 401 is at the top. The document information 401 is roughly divided into three parts: document control information 402, document setting information 403, and a chapter information list 404. The document control information 402 includes information of a document file in the file system. The document setting information 403 includes layout information such as page layout information and function setting information of the printer such as stapling setting, and corresponds to the book attribute. The chapter information list 404 includes a group of chapters that constitute the document in a list format. The list includes chapter information 405.

The chapter information 405 is also roughly divided into three parts: chapter control information 406, chapter setting information 407, and a page information list 408. The chapter control information 406 includes information such as a chapter name. The chapter setting information 407 includes page layout and stapling information unique to the chapter, and corresponds to the chapter attribute. Since the setting information can be set for each chapter, a setting of a document with a complicated layout, such as 2-up layout for the first chapter and 4-up layout for other chapters, can be realized. The page information list 408 includes a list of groups of original pages that constitute each chapter. The page information list 408 indicates page information 409.

The page information 409 is also roughly divided into three parts: page control information 410, page setting information 411, and a page data link 412. The page control information 410 stores information displayed on a tree such as a page number. The page setting information 411 includes information of a page rotation angle and a page arrangement position, and corresponds to an attribute of an original page. The page data link 412 is original data corresponding to the page. According to this example, the page information 409 does not include original data but includes only link information. The actual original data is stored in a page data list 413.

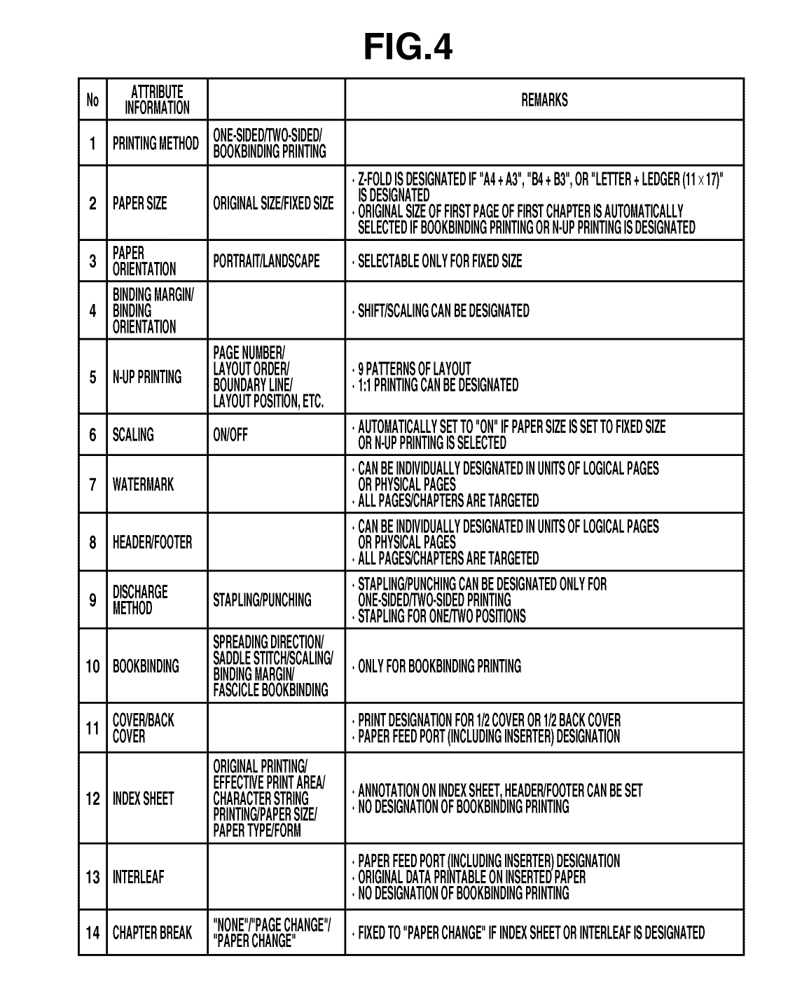

FIG. 4 illustrates an example of a list of book attributes (the document setting information 403).

Normally, the attribute value (value of the attribute information) of the lower layer is prioritized if an item which can be defined by two or more layers is set. Accordingly, as for an item included only in the book attribute, the value defined by the book attribute will be effective throughout the book.

As for an item included in both the lower layer and a different layer, if the value of the item in the lower layer is not defined, the attribute value of the item in the different layer will be set as the predetermined value. However, whether to prioritize or not prioritize the attribute value of the lower layer can be selected via a user interface (not illustrated). Each of the illustrated items does not always include one item and may include a plurality of related items.

There are five items unique to the book attribute. They are printing method, details of bookbinding, front cover/back cover, interleaf, and chapter break. Attribute values of these items are effective throughout the book. Further, three values can be designated for the printing method. They are one-sided printing, two-sided printing, and bookbinding printing. The bookbinding printing is a method for printing data in a format which allows bookbinding. A bundle of a designated number of sheets obtained by the bookbinding printing is folded in the middle after it is printed. Then, the bundle is bound and a book in a bound form is obtained. Further, if the bookbinding printing is designated as the attribute of bookbinding details, the spreading direction and the number of pages included in a bundle can be designated.

The front cover/back cover attribute includes designation of a sheet which is added as a front cover/back cover when the electronic original file which is set together as a book is printed. Further, the front cover/back cover attribute includes designation of print content of the sheet which is added.

The index sheet attribute includes designation of insertion of an index sheet with a tab, which is separately prepared for the printing apparatus. This index sheet with a tab is used for the chapter break. The index sheet attribute also includes designation of whether to print an image in the original page data input from the general application 101 on the index sheet. Furthermore, the index sheet attribute includes designation of a print area of the index sheet when an image in the original page data is printed on the index sheet. The print area is where the image in the original page data is arranged (imposed), and is determined according to an attribute such as paper size.

According to the document processing system of the present embodiment, the image in the original page data is arranged (imposed) at the center of the print area. Additionally, the index sheet attribute includes designation regarding printing of a character string on an index (tab) portion (ON/OFF, character string to be printed) as well as designation of a size, a type, and a form of the index sheet. The index attribute is enabled when an inserter for inserting a sheet other than the printing paper at desired timing, is provided for the printing apparatus or a plurality of paper cassettes can be used for the printing. The same applies to the attribute of the interleaf.

The interleaf attribute includes designation regarding insertion of a sheet used as a chapter break, which is supplied from the inserter or a sheet cassette. If an interleaf is inserted, designation of the paper feed source is also included in the interleaf attribute.

The chapter break attribute includes designation of whether to use a new sheet, use a new print page, or do nothing at a breakpoint of a chapter. If one-sided printing is selected, the use of a new sheet and the use of a new print page have the same meaning. If two-sided printing is selected and “use new sheet” is designated, consecutive chapters are not printed on one sheet. However, if “use new print page” is designated, a consecutive chapter can be printed on both sides of the sheet.

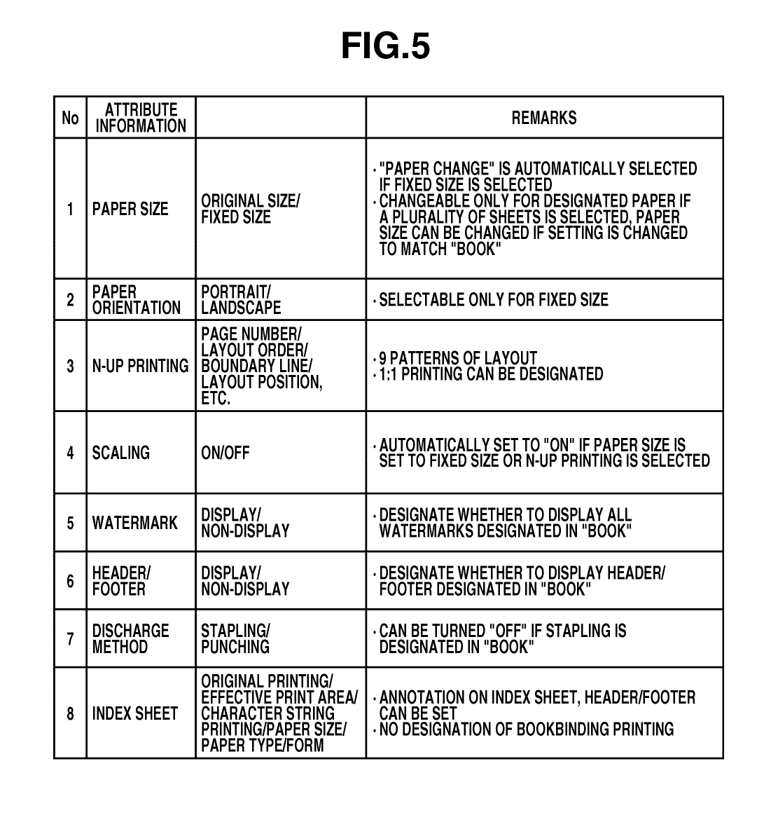

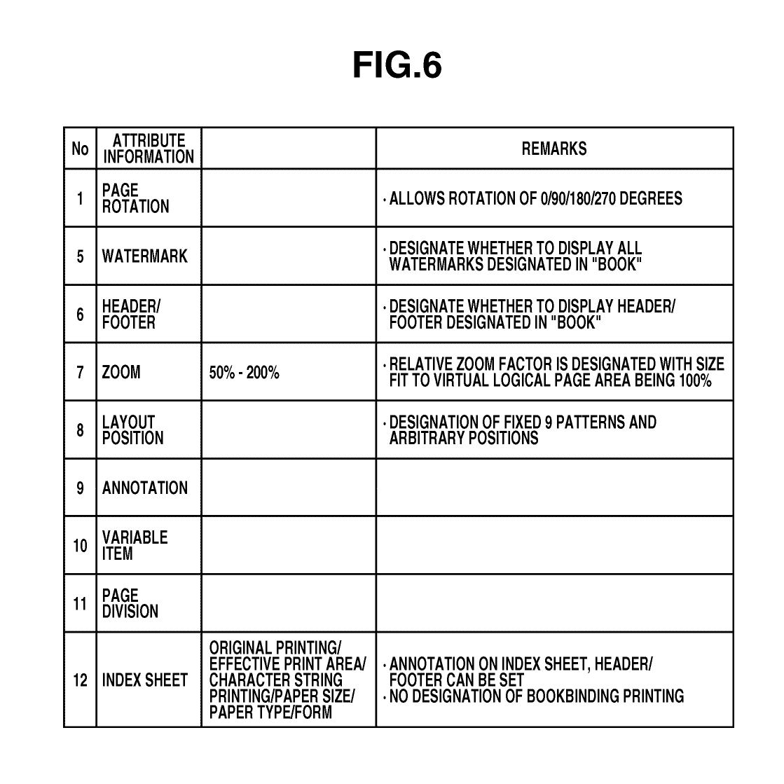

FIG. 5 illustrates an example of a list of the chapter attributes (the chapter setting information 407). FIG. 6 illustrates an example of a list of the page attributes (the page setting information 411). The relation between the chapter attributes and the page attributes is similar to the relation between the book attributes and the attributes of the lower layers.

The chapter attribute does not have a unique item and all items are included in the book attribute. Thus, normally, if a value defined by the chapter attribute and the value defined by the book attribute are different, the value defined by the chapter attribute is used on a priority basis. However, whether to prioritize the attribute value of the lower layer can be selected via the user interface.

There are eight items which are included in both the book attribute and the chapter attribute. They are paper size, sheet orientation, N-up printing, scaling, watermark, header/footer, discharge method, and index sheet.

Among these items, the N-up printing attribute is used for designating the number of original pages included in one print page. The arrangements which can be designated are, for example, 1×1, 1×2, 2×2, 3×3, and 4×4. The discharge method attribute is an item for designating whether stapling of the discharged sheets is to be performed. Validity of this attribute is determined depending on whether the printing apparatus to be used includes a staple function.

Items unique to the page attribute are page rotation designation, watermark, header/footer, zoom, arrangement position, annotation, variable item, page division, and index sheet. The page rotation attribute is used for designating a rotation angle when an original page is rotated when it is arranged on the print page. The zoom attribute is used for designating a scaling ratio of the original page. The scaling ratio is a relative ratio when the size of the virtual logical page area is 100%.

The virtual logical page area is an area of one original page when the original page is arranged according to designation such as N-up printing. For example, if the printing is 1×1, the virtual logical page area is an area corresponding to one print page. If the printing is 1×2, each side of one print page is reduced to approximately 70 percent. The index sheet attribute allows not only designation of insertion of the above-described chapter break but also designation of insertion of the page break (ON/OFF designation).

The watermark attribute and the header/footer attribute are attributes common to the book, the chapter, and the page. A watermark is an image or a character string which is separately designated and is printed over the data generated by the application. The header/footer is a watermark which is printed at the top or the bottom margin of each page. The header/footer includes items which can be designated according to a variable. They are, for example, page number and date and time.

The content of the watermark attribute and the header/footer attribute which can be designated is common to both the chapter and the page but not to the book. The content of the watermark and the header/footer can be set in the book. Further, the printing method of the watermark and the header/footer throughout the book can be designated in the book. On the other hand, whether to print a watermark or a header/footer, whose printing has been set in the book, in a specific chapter or a page can be designated for each chapter or page in the chapter or the page.

### <Operation Procedures of Document Processing System>

### (Book File Generation Procedures)

The book file includes the above-described structure and content. Generation procedures of a book file using the bookbinding application 104 and the electronic original writer 102 will now be described. Generation of a book file is realized as part of an editing operation of a book file performed by the bookbinding application 104.

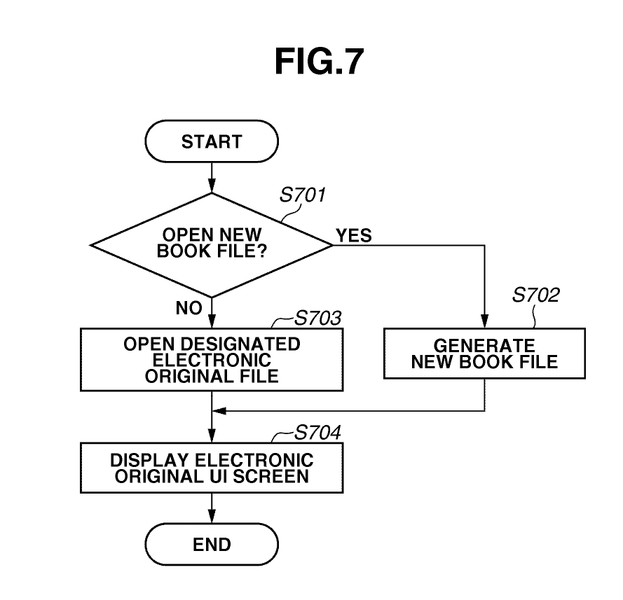

FIG. 7 is a flowchart illustrating procedures when a book file is opened by the bookbinding application 104.

In step S701, the bookbinding application 104 determines whether the book file to be opened is a book file to be newly generated or an existing book file. If a book file to be newly generated is to be opened (YES in step S701), the processing proceeds to step S702. In step S702, the bookbinding application 104 newly generates a book file that does not include a chapter.

According to the example illustrated in FIG. 3, the newly generated book file is a book node which only includes the document information 401 and no link to a chapter node (the chapter information list 404 is not included). A set of attributes prepared in advance for generation of a new book file is applied as the book attribute (the document setting information 403).

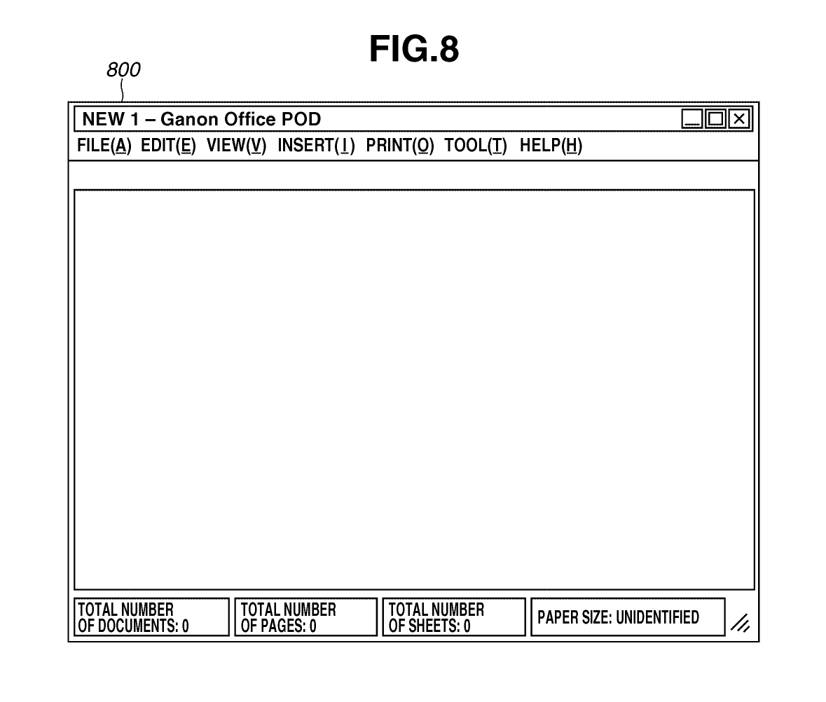

In step S704, the bookbinding application 104 displays a user interface (UI) screen used for editing the new book file. FIG. 8 illustrates an example of the UI screen which is displayed when a book file is newly generated. In this case, since the book file does not have any substantial content, no information is displayed on a UI screen 800.

On the other hand, in step S701, if an existing book file is to be opened (NO in step S701), the processing proceeds to step S703. In step S703, the bookbinding application 104 opens the designated book file. In step S704, the bookbinding application 104 displays the user interface screen according to the structure, attribute, and content of the book file.

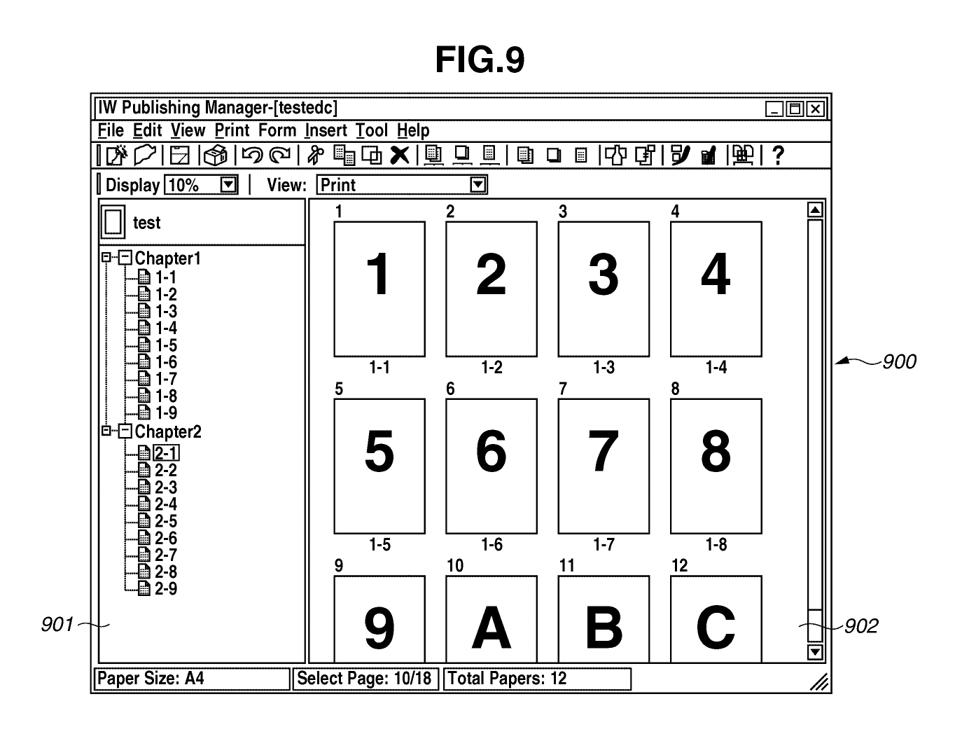

FIG. 9 illustrates an example of the user interface screen when an existing book file is opened.

A UI screen 900 includes a tree portion 901 having a book structure and a preview portion 902 displaying a state of the pages to be printed. The tree portion 901 displays chapters included in the book and pages included in each chapter in a tree structure as illustrated in FIG. 3. The pages displayed at the tree portion 901 are original pages. A reduced display of the print page is displayed in the preview portion 902. The display order of the pages reflects the book structure.

Application data converted into an electronic original file by the electronic original writer 102 can be added as a new chapter to the opened book file. This function is called an electronic original import function.

By executing the electronic original import function with respect to the book file which has been newly generated by the procedures in FIG. 7, an entity is provided to the book file. This function is started by performing a drag-and-drop operation of the application data on the screen in FIG. 8 or 9.

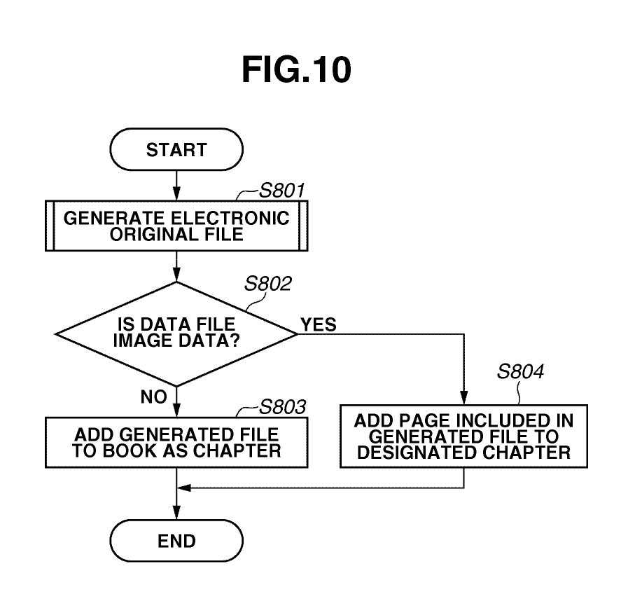

FIG. 10 is a flowchart illustrating a procedure example of the electronic original import.

In step S801, the bookbinding application 104 starts the application program that generated the designated application data and designates the electronic original writer 102 as a device driver to print the application data. According to this processing, the application data is converted into electronic original data.

In step S802, the bookbinding application 104 determines whether the converted data is image data. If the OS is Windows, the bookbinding application 104 performs this determination based on a file extension of the application data. For example, an extension “bmp” represents Windows bitmap data. Similarly, an extension “jpg” represents JPEG-compressed image data and “tiff” represents tiff-format image data.

Further, if the converted data is such image data, since the bookbinding application 104 can directly generate an electronic original file from the image data without starting the application as is performed in step S801, the processing in step S801 can be skipped.

If the converted data is not image data (NO in step S802), the processing proceeds to step S803. In step S803, the bookbinding application 104 adds the electronic original file generated in step S801 to the book of the currently-opened book file as a new chapter. Normally, as for an attribute common to the chapter attribute and the book attribute, an attribute value of the book attribute is copied. As for an attribute not common to the chapter attribute and the book attribute, a specified value prepared in advance is set for such attribute. Whether to prioritize the attribute value of the lower layer may be also selectable.

If the converted data is image data (YES in step S802), the processing proceeds to step S804. In step S804, the bookbinding application 104 does not, as a rule, add a new chapter, and adds each original page included in the electronic original file generated in step S801 to the designated chapter. If the book file is a newly generated file, however, a new chapter is generated, and each page of the electronic original file is added as a page of that chapter.

Normally, regarding a page attribute in common with an attribute in the upper layer, the attribute value of the page attribute value is employed as the attribute value. If an attribute defined by application data is also used in the electronic original file, that value is set as the attribute value. For example, if N-up printing is designated by the application data, the attribute value of the N-up printing is used. A new book file is generated or a new chapter is added in this manner. However, whether to prioritize the attribute value of the lower layer may also be selectable.

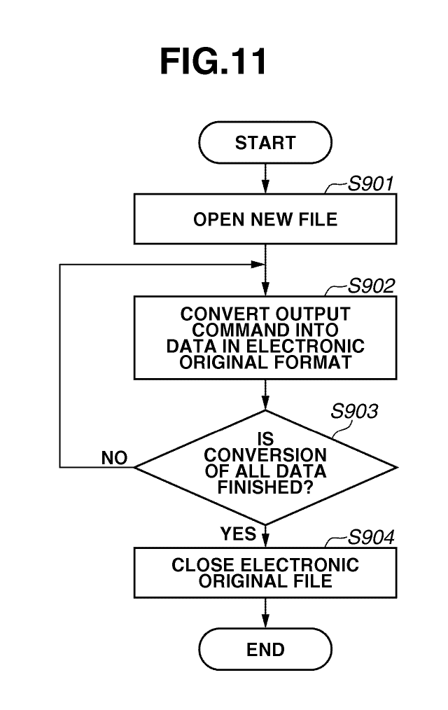

FIG. 11 is a flowchart illustrating procedures for generating an electronic original file performed by the electronic original writer 102 in step S801 in FIG. 10.

In step S901, the electronic original writer 102 generates a new electronic original file and opens the generated file. The electronic original writer 102 starts an application corresponding to designated application data. Then, an output command is transmitted to the output module of the OS using the electronic original writer 102 as the device driver.

In step S902, the output module converts the received command into data in an electronic original format using the electronic original writer, and outputs the converted data. The data is transmitted to the electronic original file opened in step S901. In step S903, the electronic original writer 102 determines whether the conversion of all the designated data has been completed. If conversion of all the designated data has been completed (YES in step S903), the processing proceeds to step S904. In step S904, the electronic original file is closed. The electronic original file generated by the electronic original writer 102 is a file including the entity of the original page data illustrated in FIG. 3.

### (Editing of Book File)

As described above, the book file can be generated from the application data. The generated book file allows editing of a chapter and a page by a user interface displayed by the bookbinding application 104 as follows:

(1) New document

### (2) Delete

### (3) Copy

### (4) Cut

### (5) Paste

### (6) Move

(7) Change chapter name
(8) Reassign page number/name
(9) Cover setting
(10) Interleaf setting
(11) Index paper setting
(12) Page layout of each original page (layout change, add blank page, etc.)

Additionally, operations for cancelling an executed editing operation and restoring the cancelled operation can be performed. According to these editing functions, for example, consolidation of a plurality of book files, rearrangement of chapters and pages in a book file, deletion of chapters and pages in a book file, layout change of an original page, and insertion of an interleaf and index sheet can be performed.

When these operations are performed, the operation result is reflected in the attributes illustrated in FIGS. 4 to 6 or reflected in the structure of the book file. For example, if an operation for newly adding a blank page is performed, a blank page is inserted in a designated portion. This blank page is treated as an original page. Further, if the layout of the original page is changed, the change is reflected in the attributes such as the printing method, N-up printing, front cover/back cover, index sheet, interleaf, and chapter break.

### <Setting of Index Paper Attribute of Document Processing System>

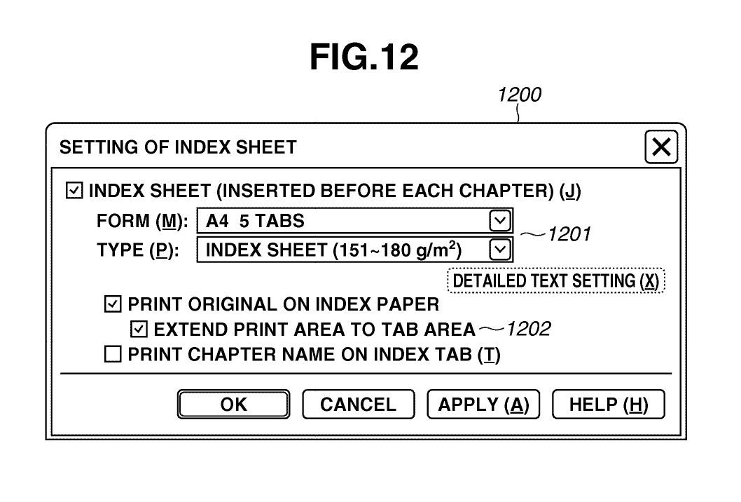

FIG. 12 illustrates an example of an “index sheet setting” window 1200 of the bookbinding application 104.

By using this window, the user can display and set an attribute of the index sheet (No. 12) in the document setting information 403. This window is displayed by the user selecting a “Setting for Index Paper” menu in the Print Form menu on the application operation screen illustrated in FIG. 9 or pressing a “Setting for Index Paper” button on the tool bar.

The “Setting for Index Paper” window is used for setting an attribute of an index sheet to be inserted in a document. Whether to use the index sheet, paper size, form, and paper type can be designated via this window. Further, whether to print the original on the index sheet, whether to enlarge the print area to the tab area of the index sheet (tab size) and arrange the original (perform imposition), and whether to print a title of the chapter on the tab of the index sheet can be designated via this window.

The attribute of the index sheet can be displayed/set also for a chapter and a page from a user interface (not illustrated).

### <Output of Book File>

As described above, the ultimate goal of the processing of the book file generated and edited in the above manner is to print it out. When the user selects a file menu of the bookbinding application illustrated in FIG. 9 via the UI screen 900 and further selects “Printing” from the menu, then the designated book file is printed and output by the designated output device. At this time, the bookbinding application 104 stores the book file which is open and transfers a file path to a repository of the book file, to the electronic original despooler 105.

The electronic original despooler 105 converts the attribute of the book file acquired from the repository of the book file into an output command of the OS, for example, a GDI command of Windows. Then, the electronic original despooler 105 performs the imposition processing of the original data of the book file. The electronic original despooler 105 sends the processed original data to an output module, for example, a GDI module. The output module generates a command appropriate for the device using the printer driver 106 which has been designated, and sends the command to the device.

More specifically, a graphics engine (not illustrated) of the output module loads the printer driver 106 prepared for each printing apparatus from the external memory 211 into the RAM 202, and sets the printer driver 106 as the output device. Then, the output module converts the received GDI function into a DDI function and outputs the DDI function to the printer driver 106.

The printer driver 106 converts the DDI function received from the output module into a printer control command, such as Page Description Language (PDL), which can be recognized by the printer. The converted printer control command is output to the printer 107 as print data via a system spooler loaded into the RAM 202 by the OS and via the interface 21.

### <Image Imposition Processing in Document Processing System of First Exemplary Embodiment>

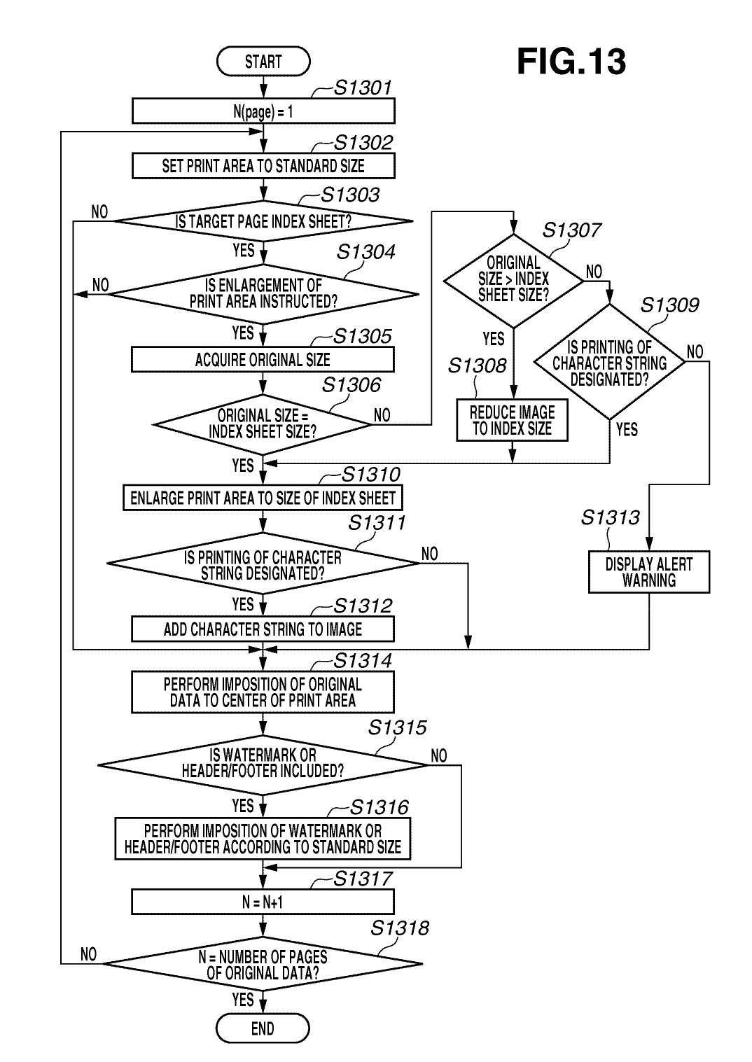

FIG. 13 is a flowchart illustrating an example of the imposition processing of original data performed by the electronic original despooler 105 in the document processing system.

In step S1301, the electronic original despooler 105 which has received the book file from the bookbinding application 104 sets the page number of the page to be imposed, to the first page of the original data (N page=1). In step S1302, the electronic original despooler 105 sets the print area (imposition area of the original image) of the page to be processed, to have the standard size (paper size (No. 2) in FIG. 4).

In step S1303, the electronic original despooler 105 determines whether the target page is an index sheet according to the attribute of the book file. To be more precise, the electronic original despooler 105 refers to the page attribute of the page to be processed and determines whether the designation of the index sheet is effective. If the electronic original despooler 105 determines that the target page is an index sheet (YES in step S1303), the processing proceeds to step S1304. If the electronic original despooler 105 determines that the target page is not an index sheet (NO in step S1303), the processing proceeds to step S1314.

In step S1304, the electronic original despooler 105 determines whether an enlargement instruction of the print area is included in the attribute of the book file (whether enlargement has been instructed with respect to the effective print area in “index sheet” (No. 12) in FIG. 4). The enlargement instruction of the effective print area is realized by the user checking a check box 1202 in FIG. 12. If the electronic original despooler 105 determines that enlargement has been instructed (YES in step S1304), the processing proceeds to step S1305. If the electronic original despooler 105 determines that enlargement has not been instructed (NO in step S1304), the processing proceeds to step S1314.

In step S1305, the electronic original despooler 105 acquires an original size being a size of the original data received from the bookbinding application 104. The original size is also a size of the image data of the page to be processed of the original data.

In step S1306, the electronic original despooler 105 determines whether the original size of the page to be processed is equal to the size of the index sheet (paper size of “index sheet” in FIG. 4 (or FIG. 5 or 6)). If the original size of the page to be processed is equal to the size of the index sheet (YES in step S1306), the processing proceeds to step S1310. In step S1310, the electronic original despooler 105 enlarges the print area of the page to be processed to the size of the index sheet.

If the original size of the page to be processed is different from the size of the index sheet (NO in step S1306), the processing proceeds to step S1307. In step S1307, the electronic original despooler 105 determines whether the original size is larger than the size of the index sheet.

If the original size is larger than the size of the index sheet (YES in step S1307), the processing proceeds to step S1308. In step S1308, the electronic original despooler 105 reduces the image of the original data to the size of the index sheet, and the processing proceeds to step S1310. On the other hand, in step S1307, if the original size is smaller than the size of the index sheet (NO in step S1307), the processing proceeds to step S1309. In step S1309, the electronic original despooler 105 determines whether printing of a character string on the index sheet is designated in the attribute of the book file.

Printing of a character string on an index sheet is enabled by the user checking “print chapter name on index tab” in FIG. 12. Whether this setting is enabled can be determined by referencing the character string printing of the “index sheet” in FIG. 4. If printing of a character string on an index sheet is designated (YES in step S1309), the processing proceeds to step S1310. If printing of a character string on an index sheet is not designated (NO in step S1309), the processing proceeds to step S1313.

After the print area is enlarged in step S1310, the processing proceeds to step S1311. In step S1311, the electronic original despooler 105 determines whether printing of a character string on the index sheet is designated in the attribute of the book file. If printing of a character string on the index sheet is designated (YES in step S1311), the processing proceeds to step S1312. In step S1312, the electronic original despooler 105 adds the character string to be printed to an appropriate position of the original data.

To be more precise, via a screen which is displayed when a text advanced setting button illustrated in FIG. 12 is pressed, a portion of the index portion (tab) where the character string can be printed is designated. The electronic original despooler 105 determines the position of the character string so that a character string such as a chapter title of the target page is printed at the position designated via the screen. The character string can be an arbitrary character string designated by the user.

In step S1309, if printing of a character string on the index sheet is not designated (NO in step S1309), the processing proceeds to step S1313. In step S1313, the electronic original despooler 105 transfers the result to the bookbinding application 104. Then, the bookbinding application 104 displays an alert warning that a character string is not printed on the index portion of the index sheet.

In step S1314, the electronic original despooler 105 performs the imposition of the original data so that the center of the original data of the page to be processed is placed in the center of the print area. At this time, the electronic original despooler 105 performs the imposition processing considering other settings of the attributes of the book file. Such attributes are, for example, binding margin/binding orientation, N-up printing, and scaling.

In step S1315, the electronic original despooler 105 determines whether a watermark or a header/footer is included in the attribute of the book file. If a watermark or a header/footer is included (YES in step S1315), the processing proceeds to step S1316. In step S1316, the electronic original despooler 105 performs the imposition of the watermark or the header/footer on the original data according to the standard size. This is because if a watermark is arranged based on a print area enlarged to the size of the index sheet, the position of that watermark will be different from the position of the watermark printed on a sheet other than the index sheet. According to this processing, such inconvenience can be prevented.

In step S1317, the electronic original despooler 105 counts up the page number of the page to be processed. In step S1318, the electronic original despooler 105 determines whether the page number has reached the number of pages of the original data. If the page number has not yet reached the number of pages of the original data (NO in step S1318), the processing returns to step S1302. If the page number has reached the number of pages of the original data (YES in step S1318), the processing ends.

### <Print Result on Index Sheet in Document Processing System>

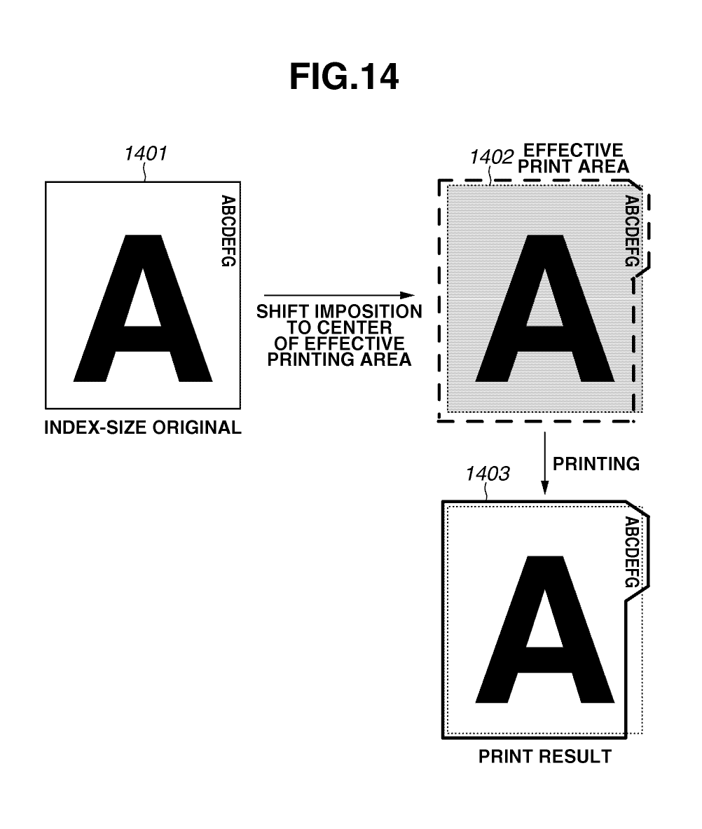

FIG. 14 illustrates an example of a print result. The print result is obtained when the electronic original despooler 105 performs the imposition processing of the original data on an index sheet according to the flowchart in FIG. 13 and the printer 107 prints the imposition-completed data.

The print result in FIG. 14 is obtained when original data 1401 in a size of the index sheet is input and the data is subjected to the imposition processing on the index sheet and the print processing. If the original data 1401 in a size of the index sheet is input, the electronic original despooler 105 performs the imposition processing in such a manner that the center of the original data 1401 is placed in the center of an enlarged effective print area 1402. Then, the printer 107 prints the original data on an index sheet 1403.

As described above, the imposition method with respect to an index sheet can be set in accordance with the format of the original data of the index sheet generated by the general application 101. Further, the print area can be changed according to the setting before the imposition processing is performed. Accordingly, flexible printing on the index sheet can be performed according to the format of the original data.

In other words, an index sheet can be printed according to the original data in various forms, for example, according to whether an image of the index (tab) portion is included in the page of the original data to be printed on the index sheet, or whether the image size is equal to the size of the index sheet.

According to the first exemplary embodiment, the imposition processing with respect to the index sheet is performed by the user setting an imposition method of the index sheet for the bookbinding application 104 in accordance with the format of the original data generated by the general application 101.

However, the imposition processing on the index paper can be automatically performed by the electronic original despooler 105 determining the format of the original data input from the general application 101.

According to a second exemplary embodiment of the present invention, the electronic original despooler 105 automatically performs the imposition processing on the index sheet. The points different from the first exemplary embodiment are mainly described with reference to the drawings.

### <Book Attribute and Chapter Attribute of Present Embodiment>

The index sheet (Nos. 12 and 8) of the book attributes in FIGS. 4 and 5 according to the present embodiment does not include information of the effective print area but includes designation information of other original printing, character string printing, paper size, paper type, and form.

### <Processing Flow of Image Imposition in Document Processing System>

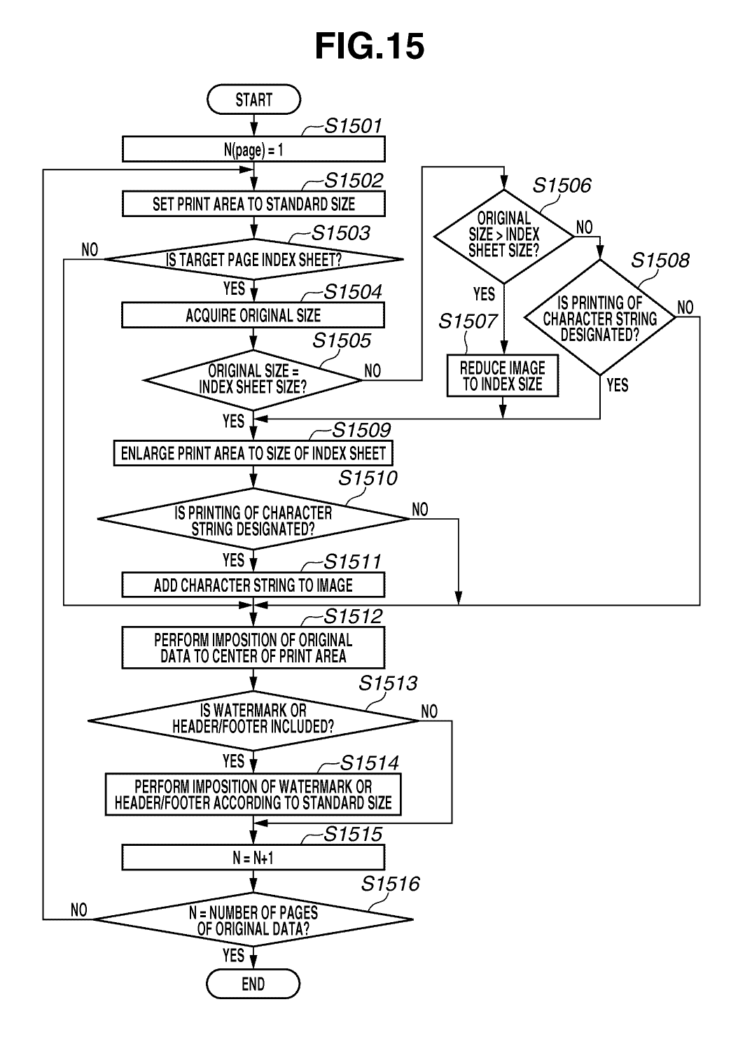

FIG. 15 is a flowchart illustrating procedures of the imposition processing of the original data performed by the electronic original despooler 105 in the document processing system according to the second exemplary embodiment of the present invention. The difference between FIGS. 13 and 15 is that the instruction in step S1304 in FIG. 13 is not included in FIG. 15. Other processing is basically similar to FIG. 13.

In step S1501, the electronic original despooler 105 which has received the book file from the bookbinding application 104 sets the page number of the page to be imposed, to the first page of the original data (N page=1). In step S1502, the electronic original despooler 105 sets the print area (imposition area of the original image) of the page to be processed to have the standard size (paper size (No. 2) in FIG. 4).

In step S1503, the electronic original despooler 105 determines whether the target page is an index sheet according to the attribute of the book file. If the electronic original despooler 105 determines that the target page is an index sheet (YES in step S1503), the processing proceeds to step S1504. If the electronic original despooler 105 determines that the target page is not an index sheet (NO in step S1503), the processing proceeds to step S1512.

If the target page is an index sheet, in step S1504, the electronic original despooler 105 acquires an original size of the original data received from the bookbinding application 104.

In step S1505, the electronic original despooler 105 determines whether the original size of the page to be processed is equal to the size of the index sheet (paper size of “index sheet” in FIG. 4 (or FIG. 5 or 6)). If the original size of the page to be processed is equal to the size of the index sheet (YES in step S1505), the processing proceeds to step S1509. In step S1509, the electronic original despooler 105 enlarges the print area of the page to be processed to the size of the index sheet.

If the original size of the page to be processed is different from the size of the index sheet (NO in step S1505), the processing proceeds to step S1506. In step S1506, the electronic original despooler 105 determines whether the original size is larger than the size of the index sheet.

If the original size is larger than the size of the index sheet (YES in step S1506), the processing proceeds to step S1507. In step S1507, the electronic original despooler 105 reduces the image of the original data to the size of the index sheet, and the processing proceeds to step S1509. On the other hand, in step S1506, if the original size is smaller than the size of the index sheet (NO in step S1506), the processing proceeds to step S1508. In step S1508, the electronic original despooler 105 determines whether printing of a character string on the index sheet is designated in the attribute of the book file.

If printing of a character string on the index sheet is designated in the attribute (YES in step S1508), the processing proceeds to step S1509. If printing of a character string on the index sheet is not designated in the attribute (NO in step S1508), the processing proceeds to step S1512.

The processing in step S1505 or steps S1505-S1508 is example processing regarding determination of whether to enlarge the print area to the area of the tab based on the size of the original data.

After the print area is enlarged in step S1509, the processing proceeds to step S1510. In step S1510, the electronic original despooler 105 determines whether printing of a character string on the index sheet is designated in the attribute of the book file. If printing of a character string on the index sheet is designated (YES in step S1510), the processing proceeds to step S1511. In step S1511, the electronic original despooler 105 adds the character string to be printed to an appropriate position of the original data.

In step S1513, the electronic original despooler 105 performs the imposition of the original data so that the center of the original data of the page to be processed is placed in the center of the print area. At this time, the electronic original despooler 105 performs the imposition processing considering other settings of the attributes of the book file. Such attributes are, for example, binding margin/binding orientation, N-up printing, and scaling.

In step S1513, the electronic original despooler 105 determines whether a watermark or a header/footer is included in the attribute of the book file. If a watermark or a header/footer is included (YES in step S1513), the processing proceeds to step S1514. In step S1514, the electronic original despooler 105 performs the imposition of the watermark or the header/footer on the original data according to the standard size.

In step S1515, the electronic original despooler 105 counts up the page number of the page to be processed. In step S1516, the electronic original despooler 105 determines whether the page number has reached the number of pages of the original data. If the page number has not yet reached the number of pages of the original data (NO in step S1516), the processing returns to step S1502. If the page number has reached the number of pages of the original data (YES in step S1516), the processing ends.

As described above, since the print area is automatically changed considering the format of the original data of the index sheet generated by the general application 101 before the imposition processing, a desired print result on the index sheet corresponding to the format of the original data can be obtained. In other words, an effect similar to the effect of the first exemplary embodiment can be obtained without increasing the load of the user.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-105380 filed May 10, 2011, which is hereby incorporated by reference herein in its entirety.

What is claimed is:

1. An information processing apparatus comprising:
a specification unit configured to specify a page to be printed on a tab sheet, of original data including a plurality of pages;
an enlarging unit configured to enlarge a print area of the page specified by the specification unit to a size of a print area of the tab sheet; and
a generation unit configured to generate print data of the page to be printed on the tab sheet specified by the specification unit using the print area enlarged by the enlarging unit.

2. The information processing apparatus according to claim 1, further comprising:
a determination unit configured to determine the print area before the print area is enlarged by the enlarging unit based on a paper size used for printing the original data; and
a setting unit configured to accept a setting from a user regarding whether to enlarge the print area determined by the determination unit to the size of the area of the tab sheet.

3. The information processing apparatus according to claim 1, wherein a position where additional information is printed is determined using the print area determined by the determination unit.

4. The information processing apparatus according to claim 1, wherein when a size of the page specified by the specification unit is equal to a size of the tab sheet, the enlarging unit enlarges the print area of the page specified by the specification unit to the size of the print area of the tab sheet.

5. A control method comprising:
specifying a page to be printed on a tab sheet, of original data including a plurality of pages;
enlarging a print area of the specified page to a size of a print area for the tab sheet; and
generating print data of the specified page to be printed on the tab sheet by using the enlarged print area.

6. The control method according to claim 5, further comprising:
determining the print area before the print area is enlarged based on a paper size used for printing the original data; and
accepting a setting from a user regarding whether to enlarge the determined print area to the size of the area of the tab sheet.

7. The control method according to claim 7, wherein a position where additional information is printed is determined by using the determined print area.

8. The control method according to claim 5, wherein when a size of the specified page is equal to a size of the tab sheet, the print area of the specified page is enlarged to the size of the print area of the tab sheet.

9. A computer-readable storage medium storing a program, which when loaded into a computer and executed performs a control method comprising:
specifying a page to be printed on a tab sheet, of original data including a plurality of pages;
enlarging a print area of the specified page to a size of a print area for the tab sheet; and
generating print data of the specified page to be printed on the tab sheet by using the enlarged print area.

10. The computer-readable storage medium according to claim 9, wherein the control method further comprises:
determining the print area before the print area is enlarged based on a paper size used for printing the original data; and
accepting a setting from a user regarding whether to enlarge the determined print area to the size of the area of the tab sheet.

11. The computer-readable storage medium according to claim 9, wherein a position where additional information is printed is determined by using the determined print area.

12. The computer-readable storage medium according to claim 9, wherein when a size of the page specified by the specification unit is equal to a size of the tab sheet, the enlarging unit enlarges the print area of the page specified by the specification unit to the size of the print area of the tab sheet.
